(19) United States
(12) Patent Application Publication
(10) Pub. No.: US 2015/0062038 A1
(43) Pub. Date: Mar. 5, 2015

(54) ELECTRONIC DEVICE, CONTROL METHOD, AND COMPUTER PROGRAM PRODUCT

(71) Applicant: Kabushiki Kaisha Toshiba, Tokyo (JP)

(72) Inventor: Kenichi TANIUCHI, Yokohama (JP)

(21) Appl. No.: 14/470,339

(22) Filed: Aug. 27, 2014

Related U.S. Application Data
(60) Provisional application No. 61/870,931, filed on Aug. 28, 2013.

(51) Int. Cl. G06F 3/041

(52) U.S. Cl. CPC G06F 3/041; G06F 2203/04104
USPC 345/173

(57) ABSTRACT

According to one embodiment, an electronic device includes a display, a first display controller, an input device, a first input controller, an input display device, a second display controller, and a second input controller. The display displays a first screen. The first display controller controls the display. The input device receives a first input on the first screen. The first input controller controls the first input. The input display device receives a second input made through a touch operation and displays a second screen related to the first screen. The second display controller controls display of the second screen on the input display device. The second input controller controls, when the second screen is displayed on the input display device, the second input as equivalent to the first input.

### CROSS-REFERENCE TO RELATED APPLICATIONS

This application claims the benefit of U.S. Provisional Patent Application No. 61/870,931, filed Aug. 28, 2013.

### FIELD

Embodiments described herein relate generally to an electronic device, a control method, and a computer program product.

### BACKGROUND

Conventionally, there has been known a note-type personal computer (PC) provided with a display and a touch pad on which a touch operation is possible. It is possible to install, into such a PC, an application requiring a touch-based user interface such as a Windows (R) Store Apps, for example.

When a user uses a keyboard and performs a touch operation to use such an application, the user needs to leave his/her hand from the keyboard once and perform a touch operation on a display. Meanwhile, when a touch operation is performed on a touch pad, the operation such as a button tap is difficult.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a hardware configuration of a PC according to an embodiment;

FIG. 2 is an exemplary diagram of the appearance of the PC in the embodiment;

FIG. 3 is an exemplary block diagram of a functional configuration of the PC in the embodiment;

FIG. 4 is an exemplary flowchart of procedures for input display processing in the embodiment;

FIG. 5 is an exemplary diagram of display on a display device and display on a touch pad in the embodiment,

FIG. 6 is an exemplary diagram of a method for specific enlargement designation in the embodiment;

FIG. 7 is an exemplary flowchart of procedures for sub window specific enlarged display processing in the embodiment;

FIG. 8 is an exemplary diagram for explaining a first modification of the embodiment; and

FIG. 9 is an exemplary diagram for explaining a third modification of the embodiment.

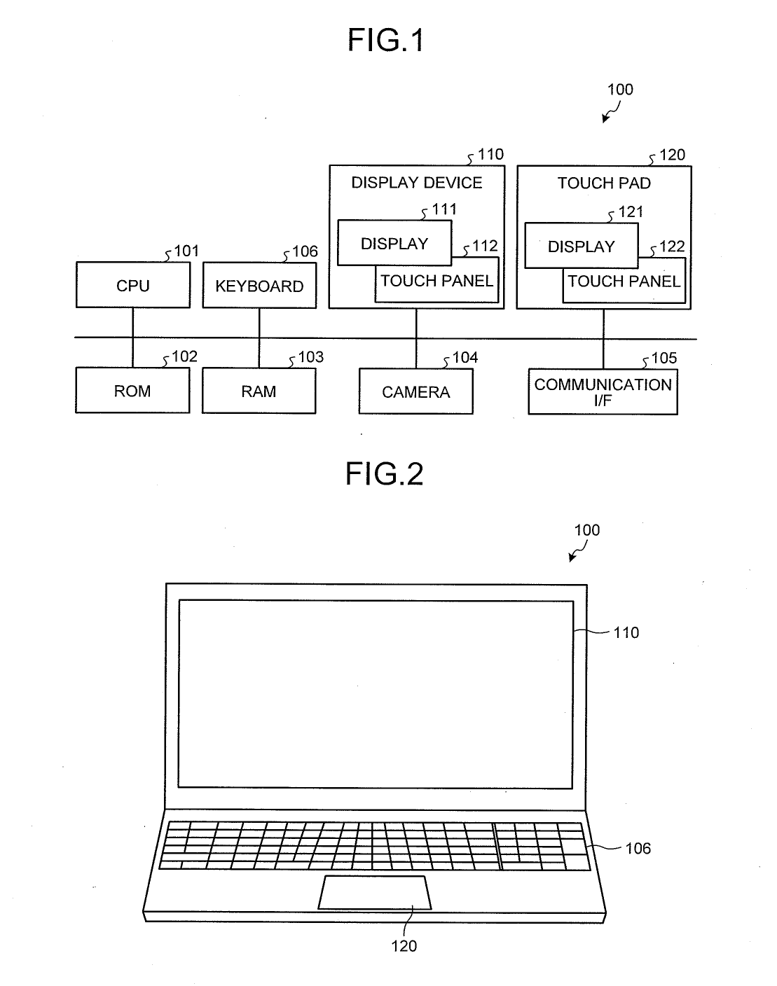

### DETAILED DESCRIPTION

In general, according to one embodiment, an electronic device comprises a display, a first display controller, an input device, a first input controller, an input display device, a second display controller, and a second input controller. The display is configured to display a first screen. The first display controller is configured to control the display. The input device is configured to receive a first input on the first screen. The first input controller is configured to control the first input. The input display device is configured to receive a second input made through a touch operation and to display a second screen related to the first screen. The second display controller is configured to control display of the second screen on the input display device. The second input controller is configured to control, when the second screen is displayed on the input display device, the second input as equivalent to the first input.

In the following, an electronic device, a control method, and a computer program product of the embodiment will be described with reference to the attached drawings. The following explains an example in which the electronic device of the embodiment is applied to a note-type personal computer (PC). However, the embodiment is not limited to a PC.

A PC 100 of the embodiment mainly comprises a central processing unit (CPU) 101, a read only memory (ROM) 102, a random access memory (RAM) 103, a keyboard 106, a camera 104, a communication interface (I/F) 105, a display device 110, and a touch pad 120.

The ROM 102 stores therein an operating system, various application programs, and various kinds of data necessary for executing programs, for example.

The CPU 101 is a processor controlling operations of the PC 100. The CPU 101 executes an operating system and various application programs loaded to the RAM 103 from an external storage medium or the ROM 102 so as to achieve modules described later (refer to FIG. 2). The RAM 103, as a main memory of the PC 100, provides a work area when the CPU 101 executes programs.

The camera 104 picks up an imaging object and outputs the picked-up image. The communication I/F 105 performs, under the control of the CPU 101, wireless communication with an external device and communication through a network such as the Internet.

The display device 110 is constituted as a so-called touch screen combining a display 111 and a touch panel 112. The display 111 is a liquid crystal display (LCD) , an organic electro luminescence (EL) display, for example. The display 111 is an example of a display device.

The touch panel 112 detects a position on a display screen of the display 111 that has been touched by a user's finger or a stylus pen, for example (touched position). The touch panel 112 is an example of an input module.

The touch pad 120 is arranged ahead of the keyboard 106, as illustrated in FIG. 2. Such a position of the touch pad 120 is a position that can be touched with a user's thumb when the user puts his/her finger on the keyboard 106 for input.

The touch pad 120 is constituted by a combination of a display 121 and a touch panel 122. The display 121 is an LCD, or an organic EL display, for example. The touch panel 122 detects a position on a display screen of the display 121 that has been touched by a user's finger or a stylus pen, for example (touched position). The touch pad 120 is an example of an input display device.

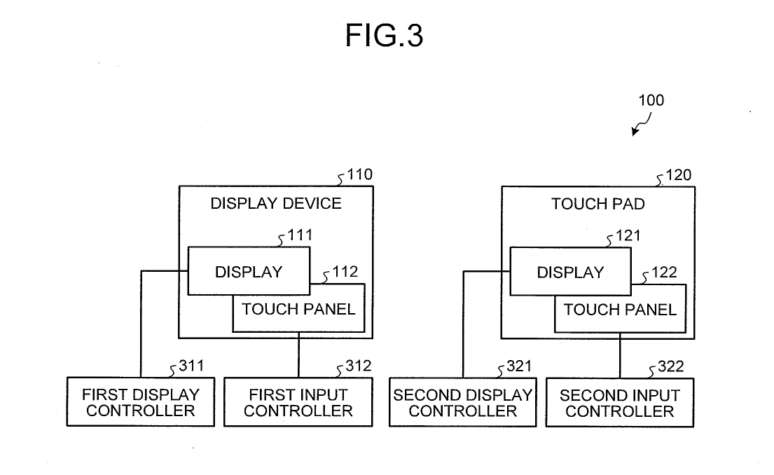

The PC 100 of the embodiment mainly comprises a first display controller 311, a first input controller 312, a second display controller 321, a second input controller 322, and the above-described display device 110 and the touch pad 120, as illustrated in FIG. 3.

The display 111 of the display device 110 can display a main window (first screen). The touch panel 112 of the display device 110 allows an input through a touch operation to the main window.

The display 121 of the touch pad 120 can display a sub window (a second screen). The touch panel 122 of the touch pad 120 allows an input through a touch operation to the sub window.

The first display controller 311 controls display of the main window on the display 111. The first input controller 312 controls an input through a touch operation through the touch panel 112 as an input to the main window.

Moreover, the first display controller 311 does not display a mouse cursor on the main window when the sub window is displayed on the display 121 of the touch pad 120, and displays a mouse cursor on the main window when the sub window is not displayed on the display 121 of the touch pad 120.

The second display controller 321 controls display of the sub window on the display 121 of the touch pad 120.

To be more specific, the second display controller 321 performs control to display the sub window on the display 121 of the touch pad 120 when a predetermined operation input is made through the touch panel 112 of the display device 110, the touch panel 122 of the touch pad 120, or the keyboard 106.

Moreover, the second display controller 321 performs control to display, as the sub window, an image of the entire area of the main window on the display 121 of the touch pad 120.

Moreover, the second display controller 321 deletes display of the sub window on the display 121 of the touch pad 120 when the display of the main window has disappeared from the display 111 of the display device 110.

When the sub window is displayed on the display 121 of the touch pad 120, the second input controller 322 controls an input through the touch panel 122 of the touch pad 120 as an input to the sub window and as an input that is equivalent to an input to the main window. When the sub window is displayed on the display 121 of the touchpad 120, the first display controller 311 does not display a mouse cursor on the main window on the display 111 of the display device 110.

On the other hand, when the sub window is not displayed on the display 121 of the touch pad 120, the second input controller 322 performs normal input control. That is, the second input controller 322 controls an input through the touch panel 122 of the touch pad 120 as an input to the main window. Moreover, when the sub window is not displayed on the display 121 of the touch pad 120, the first display controller 311 displays a mouse cursor on the main window on the display 111 of the display device 110

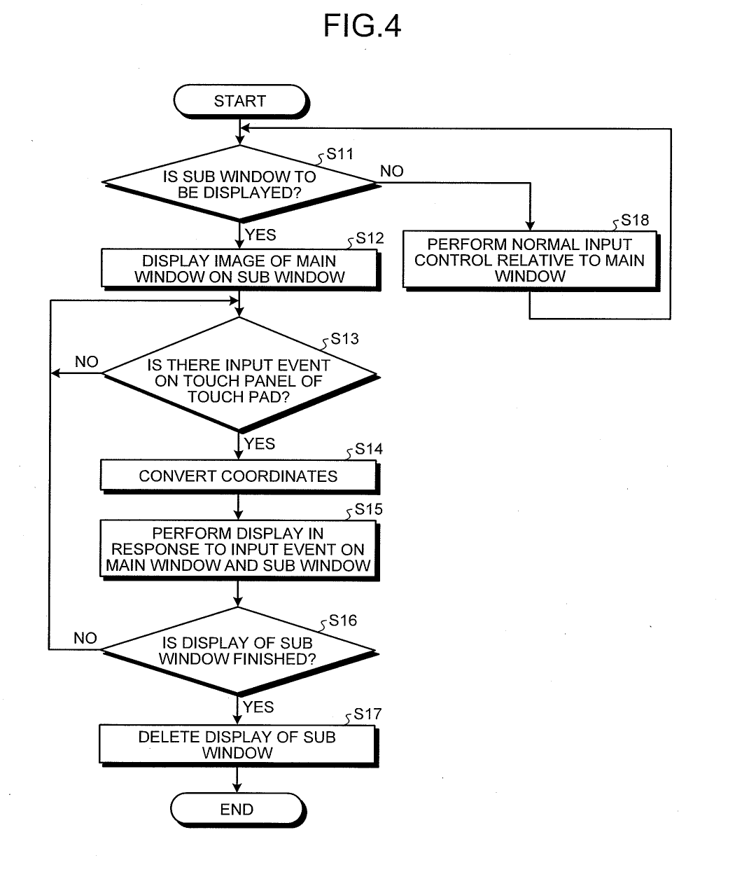

The input display processing on the touch pad 120 by the PC 100 of the embodiment will be described with reference to FIG. 4.

The second display controller 321 determines whether a sub window is to be displayed on the display 121 of the touch pad 120 (S11). To be more specific, the second display controller 321 determines whether a sub window is to be displayed on the display 121 of the touch pad 120 depending on whether the first input controller 312 has received, through the touch panel 112, a touch operation on buttons such as live tiles displayed on the main window of the display device 110 or on another graphical user interface (GUI), whether the first input controller 312 has received an input event by key pressing through the keyboard 106, or whether the second input controller 322 has received a specific touch operation (touch operations repeated a plurality of times, for example) through the touch panel 122 of the touch pad 120.

Then, when the second display controller 321 determines that a sub window is not to be displayed on the display 121 of the touch pad 120 (No at S11), the second input controller 322 performs normal input control relative to the main window of the display device 110 (S18).

That is, the second display controller 321 does not display a sub window on the display 121 of the touch pad 120. Then, the second input controller 322 regards a touch input through the touch panel 122 of the touch pad 120 as an input to the main window displayed on the display device 110. Then, the processing returns to S11.

On the other hand, when the second display controller 321 determines that a sub window is to be displayed on the display 121 of the touch pad 120 at S11 (Yes at S11), the second display controller 321 displays an image of the main window on the sub window on the display 121 of the touch pad 120 (S12). Here, the second display controller 321 displays an image of the entire area of the main window on the sub window.

Then, the second input controller 322 enters in a state of waiting for inputting a touch input event through the touch panel 122 of the touch pad 120 (No at S13).

Then, when the second input controller 322 has received a touch input event through the touch panel 122 of the touch pad 120 (Yes at S13), it converts coordinates of the touch input on the sub window into coordinates on the main window displayed on the display device 110 (S14). This is performed to convert coordinates of the input to the sub window into coordinates of the input to the main window when the resolution of the display 111 of the display device 110 is different from the resolution of the display 121 of the touch pad 120.

For example, when the resolution of the display 111 (main window) of the display device 110 is 1366×768 pixels, and the resolution of the display 121 (sub window) of the display device 110 is 800×600 pixels, the second input controller 322 notifies, when a position of coordinates (X, Y) on the sub window has been touched, the second display controller 321 of the touch operation realized on the coordinates ((X/800)×1366, (Y/600)×768).

Next, the first display controller 311 performs display in response to the input event on the main window, and the second display controller 321 performs display in response to the input event on the sub window (S15). Thus, the same display is performed on the main window and the sub window.

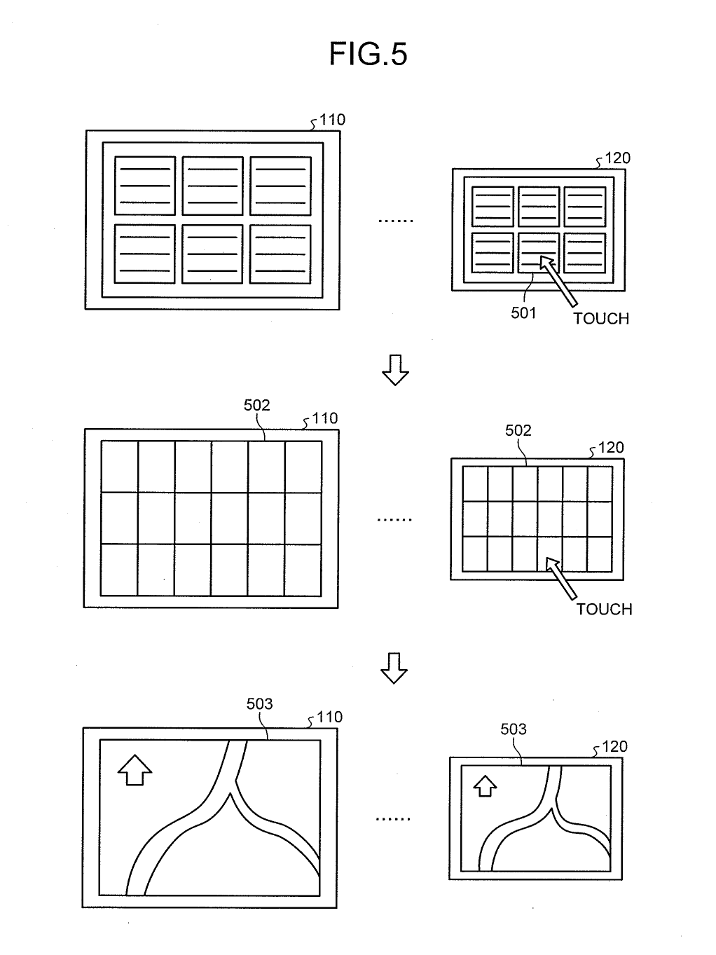

Here, a display example by the processing at S15 will be described with reference to FIG. 5. FIG. 5 illustrates an example in which an image of the entire area of the main window displayed on the display 111 of the display device 110 is displayed as a sub window on the display 121 of the touch pad 120.

As illustrated in FIG. 5, when a user performs a touch operation on a live tile 501 of the sub window displayed on the touch pad 120, a following screen 502 is displayed. This touch operation is reflected in both the main window and the sub window, and the following screen 502 is displayed on both the main window and the sub window.

Furthermore, when the user performs a touch operation on the screen 502 of the sub window displayed on the touch pad 120, a following map screen 503 is displayed. This touch operation is reflected in both the main window and the sub window, and the following map screen 503 is displayed on both the main window and the sub window, as illustrated in FIG. 5.

Moreover, the second input controller 322 receives an input for enlargement designation such as pinching out of an image on the main window displayed on the sub window by touching each one of the end points that constitute diagonals of a partial area of the image, that is, pinching out by touching two end points that are diagonals of the partial area. Here, pinching out is an operation for expanding a plurality of touched points. Such enlargement designation is referred to as normal enlargement designation.

In this case, the first display controller 311 performs enlarged display, as a main window, of an image of the area (a partial area) having touch-operated coordinates on the sub window as end points of the diagonal line, with an enlargement ratio in accordance with the movement amount of the pinched-out touched points, on the display 111 of the display device 110. Moreover, the second display controller 321 performs enlarged display, as a sub window, of an image of the area having coordinates based on the touch operation for enlargement designation such as pinching out as end points of the diagonals, with the above enlargement ratio, on the display 121 of the touch pad 120. In this manner, the enlarged display of the image of the specified area is performed on both the main window and the sub window.

Moreover, the second input controller 322 receives, through the image of the main window displayed on the sub window, an input for reduction designation by the operation of moving a finger in the opposite direction of the case of enlargement designation (pinching out) while touching each one of the end points that constitute diagonals of a partial area of the image. In this case, the first display controller 311 performs reduced display, as a main window, of an image of the area having touch-operated coordinates on the sub window as end points of the diagonal line, with a reduction ratio in accordance with the movement amount of the touched points, on the display 111 of the display device 110. Moreover, the second display controller 321 performs reduced display, as a sub window, of an image of the area having coordinates based on the touch operation for reduction designation as end points of the diagonals, with the above reduction ratio, on the display 121 of the touch pad 120. In this manner, the reduced display of the image of the specified area is performed on both the main window and the sub window.

Returning to FIG. 4, the second display controller 321 subsequently determines whether the display of the sub window is to be finished depending on whether the display of the main window has disappeared from the display 111 of the display device 110 (S16). When the main window is displayed on the display 111 of the display device 110, and the second display controller 321 determines that the display of the sub window is not to be finished (No at S16), the processing returns to S13, and the processing at S14 and S15 is performed.

On the other hand, when the display of the main window has disappeared from the display 111 of the display device 110, and the second display controller 321 determines that the display of the sub window is to be finished (Yes at S16), the second display controller 321 deletes the display of the sub window from the display 121 of the touch pad 120 (S17).

Moreover, the second display controller 321 performs control to display, as a sub window, an image of a partial area of the main window on the display 121 of the touch pad 120.

Here, when the second input controller 322 has received an input for specific enlargement designation relative to the sub window, it does not control the input as an input to the main window, and regards the input as an input to only the sub window. That is, when the specific enlargement designation is performed on the touch panel 122 of the touch pad 120, the first display controller 311 does not enlarge the image on the main window of the display device 110, and the second display controller 321 performs enlarged display on only the sub window of the touch pad 120.

Such specific enlargement designation is not by pinching out by two-point touch, which is normal enlargement designation, and exemplified by pinching out by four-point touch in which two points each of end points that are diagonals of an area to be enlarged are touched for pinching out, for example.

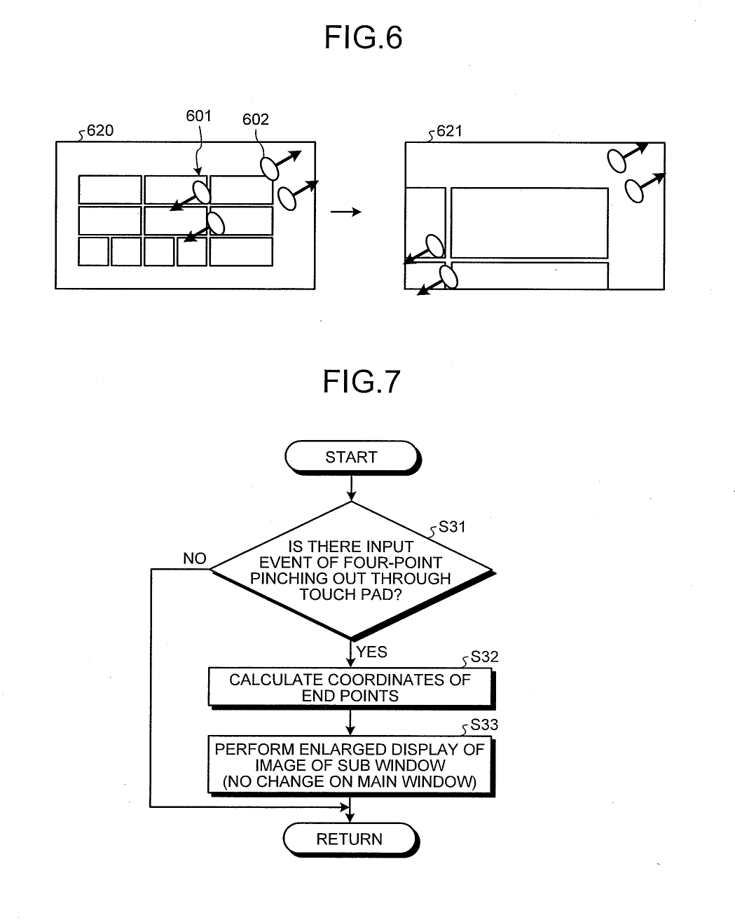

For example, a user performs two-point touch at each of end points 601 and 602 that constitute diagonals of an area that the user intends to enlarge, that is, four-point touch in total, on a sub window 620 before enlargement in FIG. 6. Then, when the user pinches out by moving two end points each in an enlargement direction (arrow direction) while keeping the four-point touch state, the second input controller 322 receives an input for specific enlargement designation by such four-point pinching out. Then, the second display controller 321 performs enlarged display of the specified area with an enlargement ratio in accordance with the movement amount of the pinched-out touched points, as displayed on a sub window 621 after enlargement.

Note that such specific enlargement designation is not limited to by four-point pinching out, and any method can be applied optionally as long as it is a designation method different from the normal enlargement designation.

The processing for such specific enlarged display of only an image of the sub window will be described with reference to FIG. 7. The second input controller 322 determines whether an input event of pinching out by four-point touch has been received from the touch panel 122 of the touch pad 120 (S31).

Then, when the second input controller 322 has not received an input event of pinching out by four-point touch (No at S31), it finishes the processing. On the other hand, when the second input controller 322 has received an input event of pinching out by four-point touch (Yes at S31), the second input controller 322 calculates coordinates of a midpoint of two touched points for each end point (S32). For example, it is supposed that in FIG. 6, the coordinates of two touched points of the symbol 601 are (x1a, y1a) and (x1b, y1b), respectively, and the coordinates of two touched points of the symbol 602 are (x2a, y2a) and (x2b, y2b), respectively. In this case, the second input controller 322 calculates the coordinates of a midpoint of the two touched points of the symbol 601 as ((x1a+x1b)/2, (y1a+y1b)/2) , and the coordinates of a midpoint of the the two touched points of the symbol 602 as ((x2a+x2b)/2, (y2a+y2b)/2). Then, the second input controller 322 supposes that such two midpoints ((x1a+x1b)/2, (y1a+y1b)/2), ((x2a+x2b)/2, (y2a+y2b)/2) have been touched for enlargement designation, and transmits them to the second display controller 321. The second display controller 321 performs enlarged display of the area having the two midpoints as diagonals on the sub window (S33).

Only the area of the sub window is enlarged for display by such specific enlargement designation because of the following reasons. The screen size of the sub window is small. Thus, the touch operation thereon is more difficult as compared with a touch operation on the main window, and errors in a touch operation can occur more easily. In such a case, the user performs specific enlargement designation different from the normal enlargement designation so that the enlarged display of an area specified by specific enlargement designation is performed only on the sub window, which can facilitate a touch operation on the sub window.

Moreover, when specific enlargement designation is made, the enlarged display of only the area of the sub window is performed. Thus, it is possible to perform the operation distinctively from a case of enlargement designation relative to the main window.

Note that also in case of reduced display, the second input controller 322 can be configured in the same manner as in specific enlargement designation described above. That is, when the user moves his/her finger in a direction opposite to the direction illustrated in FIG. 6 while keeping four-point touch on the touch pad 120, the second input controller 322 receives the touch operation as an input for specific reduction designation, and regards the input as an input to only the sub window without controlling the input as an input to the main window. That is, when the specific reduction designation is performed on the touch panel 122 of the touch pad 120, the first display controller 311 does not reduce an image of the main window of the display device 110, and the second display controller 321 performs reduced display relative to only the sub window of the touch pad 120 with a reduction ratio in accordance with the movement amount of the touched points.

As described above, in the embodiment, the second display controller 321 performs display of the main window on the display 111 of the display device 110 also on the sub window on the display 121 of the touch pad 120. Moreover, in the embodiment, when the sub window is displayed on the display 121 of the touch pad 120, the second input controller 322 regards an input through the touch panel 122 of the touch pad 120 as an input to the sub window and as an input to the main window.

In this manner, in the embodiment, the touch operation by the user can be performed relative to the sub window. Thus, the user can perform the touch operation without leaving his/her hand from the keyboard 106, which can improve the operational efficiency.

Moreover, it is possible to directly operate, by touch, icons and the like displayed on the display 121 of the touch pad 120. Thus, the number of touch operations on the touch panel 112 of the display device 110 can be reduced, which can reduce adherence of fingerprints on the touch panel 112 of the display device 110.

First Modification

In the embodiment described above, the second display controller 321 performs enlarged display of an area specified by a user by enlargement designation such as pinching out . However, the second display controller 321 may be configured to determine an area to be enlarged for display with a predetermined condition without user's designation and perform enlarged display of an image of the determined area as a sub window on the display 121 of the touch pad 120.

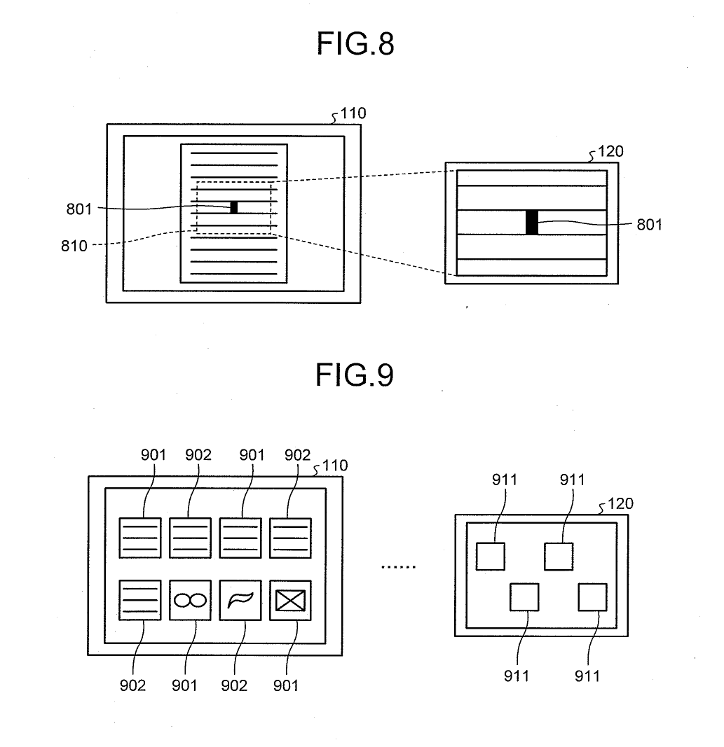

As one example of this, as illustrated in FIG. 8, for example, when a document preparation screen is displayed on the main window of the display device 110, and the user is inputting apart specified by a cursor 801 with the keyboard 106, the second display controller 321 may be configured to determine a surrounding area 810 that is within a predetermined area from the cursor 801 and perform enlarged display, as a sub window, of an image of the determined area 810 surrounding the cursor 801 on the display 121 of the touch pad 120.

For example, when the user is preparing a document while moving his/her finger on the keyboard 106, he/she may select and specify any area from points specified by a cursor for cut and paste, for example. Also in such a case, the user can perform the specified selection operation by only putting his/her thumb on the touch pad 120 without leaving his/her finger from the keyboard 106. Therefore, in the modification, the user does not need to interrupt an input operation for the selection operation, which can improve the efficiency of the operation.

Second Modification

Moreover, as an example in which the enlarged display of an area is performed with a predetermined condition without user's designation, an imaging module such as the camera 104 may be provided in the PC 100 so that the camera 104 picks up an image of a user, and users' viewpoints are detected using a known viewpoint detection technique based on the picked-up image. The second display controller 321 may be configured to determine a given area based on the detected user' viewpoints and perform control to display, as a sub window, an image of the determined given area on the display 121 of the touch pad 120.

Third Modification

In the embodiment described above, the second display controller 321 displays an image of the entire or a part of the main window as it is on the sub window. However, the embodiment is not limited thereto. For example, the second display controller 321 maybe configured to display, as a sub window, an image obtained by simplifying the main window on the display 121 of the touch pad 120.

As one example of this, as illustrated in FIG. 9, for example, the second display controller 321 can be configured to display, as a sub window, only live tiles and icons that can be specified by a user among live tiles and icons displayed on the main window, as an image obtained by simplifying the image of the live tiles and icons, on the display 121 of the touch pad 120.

In the example of FIG. 9, it is supposed that live tiles 901 can be selected by the user and live tiles 902 cannot be selected by the user on the main window of the display device 110. In this case, the second display controller 321 displays only the live tiles that can be selected, as symbols 911, on the sub window of the touch pad 120, and displays the image of the live tiles 911 in a more simplified manner than the image on the main window. Thus, the sub window that is a small area displays only necessary information in a simplified manner, which is an advantage of enabling the user to see the information more easily.

Fourth Modification

In the above embodiment, when the second display controller 321 has received a predetermined operation by a user, it determines that a sub window is to be displayed on the display 121 of the touch pad 120. However, the embodiment is not limited thereto. The second display controller 321 may be configured to display the sub window on the display 121 of the touch pad 120 when a predetermined condition is fulfilled without user's designation.

As one example of this, the second display controller 321 may be configured to display the sub window on the display 121 of the touch pad 120 when a predetermined specific screen is displayed on the main window.

Examples of such a specific screen include Windows (R) Store Apps screens. That is, the second display controller 321 may be configured to display, as a sub window, a Windows (R) Store Apps screen on the display 121 of the touch pad 120 when the Windows (R) Store Apps is activated and the Windows (R) Store Apps screen is displayed on the main window, without performing display on the sub window while, for example, a desktop screen is displayed on the main window.

Alternatively, a human sensor may be provided in the vicinity of the keyboard 106 or the touch pad 120, and the second display controller 321 can be configured to display the sub window on the display 121 of the touch pad 120 when detection signals are transmitted by the human sensor.

In such a manner, the sub window is displayed without user's designation, which can reduce operation efforts of the user.

Fifth Modification

Moreover, in the embodiment described above, the sub window is deleted from the display 121 of the touch pad 120 when the display of the main window has disappeared from the display device 110. However, the timing at which the sub window is deleted is not limited thereto.

For example, the second display controller 321 can be configured to delete the sub window from the display 121 of the touch pad 120 when it has not received an input through the touch panel 122 of the touch pad 120 by the second input controller 322 during a certain period of time.

An input display control program executed in the PC 100 in the embodiments and the modifications described above may recorded, as a file whose format is installable or executable, in a computer readable recording medium such as a CD-ROM, a flexible disk (FD), a CD-R, and a Digital Versatile Disk (DVD), and then provided as a computer program product.

Moreover, the input display control program executed in the PC 100 in the embodiments and the modifications described above may be stored in a computer connected to a network such as the Internet, and then provided by download thereof through the network. Alternatively, the input display control program executed in the PC 100 in the embodiments and the modifications described above maybe provided or distributed through a network such as the Internet.

Moreover, the input display control program executed in the PC 100 in the embodiments and the modifications described above may be preliminarily embedded and provided in the ROM 102, for example.

The input display control program executed in the PC 100 in the embodiments and the modifications described above is of a module configuration comprising the modules described above (first input controller 312, first display controller 311, second input controller 322, second display controller 321). The CPU 101 reads out the input display control program from the recording medium, and executes it, whereby the modules described above are loaded on the RAM 103, and the first input controller 312, the first display controller 311, the second input controller 322, and the second display controller 321 are generated on the RAM 103.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An electronic device, comprising:
a display configured to display a first screen;
a first display controller configured to control the display;
an input device configured to receive a first input on the first screen;
a first input controller configured to control the first input;
an input display device configured to receive a second input made through a touch operation and to display a second screen related to the first screen;
a second display controller configured to control display of the second screen on the input display device; and
a second input controller configured to control, when the second screen is displayed on the input display device, the second input as equivalent to the first input.

2. The electronic device of claim 1, wherein the second input controller is configured to control, when the second display is not displayed on the input display device, the second input as an input to the first screen.

3. The electronic device of claim 1, wherein the second display controller is configured to display an image of an entire area of the first screen as the second screen on the input display device.

4. The electronic device of claim 1, wherein the second display controller is configured to display an image of a partial area of the first screen as the second screen on the input display device.

5. The electronic device of claim 4, wherein the second input controller is configured to receive an input for designating the partial area on the second screen.

6. The electronic device of claim 5, wherein
the second input controller is configured to receive an input for enlargement designation made through a touch operation on two or more points for each end point constituting a diagonal line of the partial area on the second screen,
the first display controller is configured not to enlarge display of the first screen, and
the second display controller is configured to display an enlarged image of the partial area having coordinates based on the touch operation for enlargement designation as the end points of the diagonal line on the input display device as the second screen.

7. The electronic device of claim 4, wherein the second display controller is configured to determine the partial area with a first condition through the first screen, and to display, as the second screen, an image of the determined partial area on the input display device.

8. The electronic device of claim 7, wherein the second display controller is configured to determine, as the partial area, a first range from a cursor displayed on the first screen, and to display, as the second screen, an image of the determined partial area on the input display device.

9. The electronic device of claim 1, wherein the second display controller is configured to display, as the second screen, a screen obtained by simplifying the first screen on the input display device.

10. The electronic device of claim 9, wherein the second display controller is configured to display the second screen, in which selectable icons among icons displayed on the first screen are displayed as a simplified image of the selectable icons on the input display device.

11. The electronic device of claim 1, wherein the second display controller is configured to display the second screen on the input display device when a first operation input is made.

12. The electronic device of claim 1, wherein the second display controller is configured to delete the second screen on the input display device when the first screen disappeared from the display.

13. A control method, comprising:
controlling display of a first screen on a display;
controlling a first input through an input device configured to receive the first input to the first screen;
controlling display of a second screen on an input display device configured to receive a second input made through a touch operation and to display the second screen related to the first screen; and
controlling, when the second screen is displayed on the input display device, the second input as equivalent to the first input.

14. A computer program product having a non-transitory computer readable medium including programmed instructions, wherein the instructions, when executed by a computer, cause the computer to perform:
controlling display of a first screen on a display;
controlling a first input through an input device configured to receive the first input to the first screen;
controlling display of a second screen on an input display device configured to receive a second input made through a touch operation and to display the second screen related to the first screen; and
controlling, when the second screen is displayed on the input display device, the second input as equivalent to the first input.
